(19) United States
(12) Patent Application Publication
(10) Pub. No.: US 2025/0013751 A1
(43) Pub. Date: Jan. 9, 2025

(54) FULLY ENCRYPTED OPERATING SYSTEM INSTALLATION MEDIA

(71) Applicant: Forcepoint Federal Holdings LLC, Austin, TX (US)

(72) Inventors: Robert Walker KLIEWER, Wylie, TX (US); Chad John HANSON, Alexandria, VA (US); Micky Stuart MARTIN, Rowlett, TX (US)

(73) Assignee: Forcepoint Federal Holdings LLC, Austin, TX (US)

(21) Appl. No.: 18/347,375

(22) Filed: Jul. 5, 2023

(51) Int. Cl. G06F 21/57

(52) U.S. Cl. CPC G06F 21/575; G06F 2221/034

(57) ABSTRACT

A computer-implementable method may include booting an information handling system from a boot image stored on a non-transitory computer-readable storage medium, prompting, by the boot image, for a password for an encrypted volume of the non-transitory computer-readable storage medium, loading, by the boot image, a kernel stored within the encrypted volume, passing, by the boot image, the password to a specialized module stored within the encrypted volume, decrypting, by the specialized module, the encrypted volume using the password, and causing, by the specialized module, execution of an operating system installation image stored within the encrypted volume to install the operating system on the information handling system.

### FIELD OF DISCLOSURE

The present invention relates in general to the field of computers and similar technologies, and in particular to software utilized in this field. Still more particularly, it 5 relates to a method, system, and computer-usable medium for making and using fully encrypted operating system installation media.

### BACKGROUND

To ensure greater levels of computer security, it may be desirable to encrypt installation media for installing an operating system on a computer. Using existing approaches, a vendor of an operating system encrypts an installation image (e.g., in an ISO file) before delivering the installation image to its customer. Such approach requires that the customer decrypt the media and write the decrypted installation image to optical media in order to install the operating system. Such process may be cumbersome for the customer as technicians may lack the technical expertise or necessary equipment.

### SUMMARY

In accordance with the teachings of the present disclosure, certain disadvantages and problems associated with existing approaches to making and using encrypted installation media for operating systems have been reduced or eliminated.

In accordance with embodiments of the present disclosure, a computer-implementable method may include booting an information handling system from a boot image stored on a non-transitory computer-readable storage medium, prompting, by the boot image, for a password for an encrypted volume of the non-transitory computer-readable storage medium, loading, by the boot image, a kernel stored within the encrypted volume, passing, by the boot image, the password to a specialized module stored within the encrypted volume, decrypting, by the specialized module, the encrypted volume using the password, and causing, by the specialized module, execution of an operating system installation image stored within the encrypted volume to install the operating system on the information handling system.

In accordance with embodiments of the present disclosure, a system may include a processor and a non-transitory, computer-readable storage medium embodying computer program code, the non-transitory, computer-readable storage medium being coupled to a data bus, the computer program code interacting with a plurality of computer operations and comprising instructions executable by the processor and configured for generating a second non-transitory computer-readable storage medium comprising a program of instructions configured for, when read and executed by a processing device: booting an information handling system from a boot image stored on the non-transitory computer-readable storage medium; prompting, by the boot image, for a password for an encrypted volume of the non-transitory computer-readable storage medium; loading, by the boot image, a kernel stored within the encrypted volume; passing, by the boot image, the password to a specialized module stored within the encrypted volume; decrypting, by the specialized module, the encrypted volume using the password; and causing, by the specialized module, execution of an operating system installation image stored within the encrypted volume to install the operating system on the information handling system.

In accordance with embodiments of the present disclosure, a non-transitory, computer-readable storage medium embodying computer program code is disclosed, the computer program code comprising computer executable instructions configured for: booting an information handling system from a boot image stored on a non-transitory computer-readable storage medium; prompting, by the boot image, for a password for an encrypted volume of the non-transitory computer-readable storage medium; loading, by the boot image, a kernel stored within the encrypted volume; passing, by the boot image, the password to a specialized module stored within the encrypted volume; decrypting, by the specialized module, the encrypted volume using the password; and causing, by the specialized module, execution of an operating system installation image stored within the encrypted volume to install the operating system on the information handling system.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates an example information handling system in which the methods and systems disclosed herein may be implemented, in accordance with embodiments of the present disclosure;

FIG. 2 illustrates a flow chart of an example method for creating storage media having an encrypted installation image for installation of an operating system, in accordance with embodiments of the present disclosure; and

FIG. 3 illustrates a flow chart of an example method of execution of storage media having an encrypted installation image for installation of an operating system, in accordance with embodiments of the present disclosure.

### DETAILED DESCRIPTION

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a consumer electronic device, a mobile device such as a tablet or smartphone, a connected “smart device,” a network appliance, a network storage device, or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more communications ports for communicating with networked devices, external devices, and various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

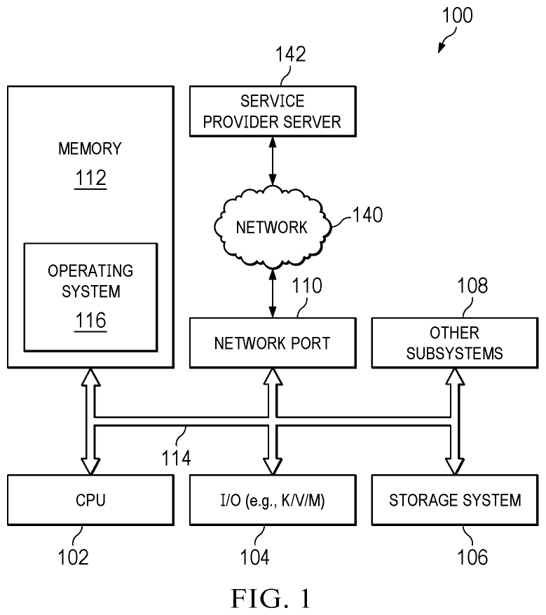

FIG. 1 illustrates an example information handling system 100 in which the methods and systems disclosed herein may be implemented, in accordance with embodiments of the present disclosure. Information handling system 100 may include a processor (e.g., central processor unit or “CPU”) 102, input/output (I/O) devices 104 (e.g., a display, a keyboard, a mouse, and/or associated controllers), a storage system 106, and various other subsystems 108. In various embodiments, information handling system 100 may also include network port 110 operable to couple to a network 140, which may likewise be accessible by a service provider server 142. Information handling system 100 may also include system memory 112, which may be coupled to the foregoing via one or more buses 114. System memory 112 may store operating system (OS) 116.

In some embodiments, storage system 106 may include one or more interfaces for removable storage media, such as, for example, an optical disc drive for reading and/or writing optical storage media (e.g., compact disc, Digital Versatile Disc, BluRay disc, etc.) and/or a port (e.g., Universal Serial Bus port) for reading to and/or writing from an external flash drive (e.g., a Universal Serial Bus “thumb drive”).

In operation, information handling system 100 or a similar information handling system may be configured to generate storage media having an encrypted installation image for installation of an operating system, as described in greater detail below. Further, information handling system 100 or a similar information handling system may be configured to read storage media having an encrypted installation image for installation of an operating system (e.g., operating system 116) and install the operating system from such storage media, as described in greater detail below.

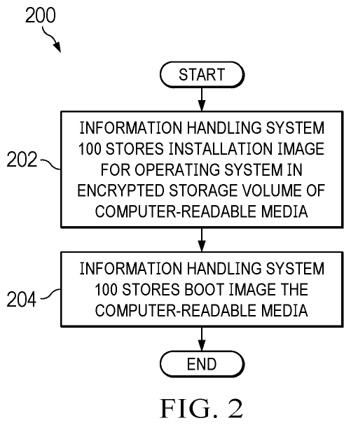

FIG. 2 illustrates a flow chart of an example method 200 for creating storage media having an encrypted installation image for installation of an operating system, in accordance with embodiments of the present disclosure. According to some embodiments, method 200 may begin at step 202. As noted above, teachings of the present disclosure may be implemented in a variety of configurations of information handling system 100. As such, the preferred initialization point for method 200 and the order of the steps comprising method 200 may depend on the implementation chosen.

At step 202, information handling system 100 may store an installation image for an operating system in an encrypted storage volume (e.g., a Linux Unified Key Setup (LUKS) volume) of computer-readable media (e.g., an optical disc or external flash drive). At step 204, information handling system 100 may also store a boot image for the computer-readable media. As described in greater detail below, such boot image may include necessary instructions for enabling another information handling system to boot from the computer-readable media, including instructions for detecting the existence of the encrypted storage volume and instructions for prompting for a password to decrypt the encrypted storage volume. In some embodiments, such boot image may be a Grand Unified Boot Loader (GRUB) image. After step 204, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using CPU 102 and/or any other system operable to implement method 200. In some embodiments, method 200 may be implemented partially or fully in software and/or firmware embodied in computer-readable media.

After the computer-readable media with the boot image and the encrypted storage volume having the installation image for the operating system is created, a vendor of the operating system may deliver the computer-readable media to a customer, and also deliver a password for decryption of the encrypted storage volume in a different manner than delivery of the computer-readable media. For example, the computer-readable media and password may be delivered in different physical parcels, or the computer-readable media may be physically delivered via parcel while the password is delivered electronically (e.g., via electronic mail).

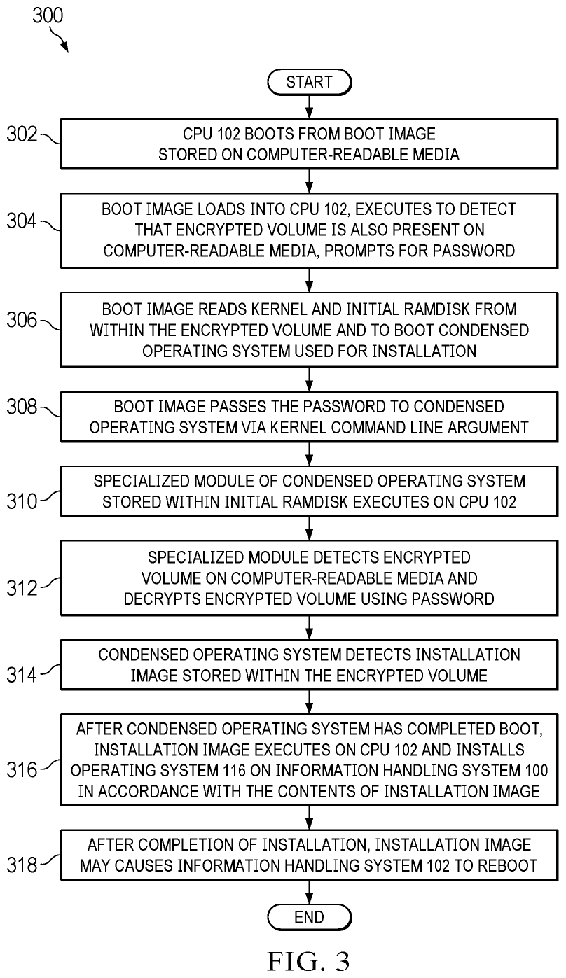

FIG. 3 illustrates a flow chart of an example method 300 of execution of storage media having an encrypted installation image for installation of an operating system, in accordance with embodiments of the present disclosure. According to some embodiments, method 300 may begin at step 302. As noted above, teachings of the present disclosure may be implemented in a variety of configurations of information handling system 100. As such, the preferred initialization point for method 300 and the order of the steps comprising method 300 may depend on the implementation chosen.

At step 302, in response to the computer-readable media being coupled to an appropriate interface (e.g., optical media placed in an optical disc drive, external flash drive coupled to a Universal Serial Bus port, etc.) of an information handling system 100 (e.g., a different information handling system 100 than that used to create the computer-readable media) and powering on of the information handling system, CPU 102 may boot from the boot image stored on the computer-readable media. At step 304, the boot image may load into CPU 102 and may execute to detect that the encrypted volume is also present on the computer-readable media and in response, prompt for a password for decryption.

At step 306, in response to receipt of the correct password (e.g., via an I/O device 104), the boot image, executing on CPU 102, may read the kernel and initial ramdisk from within the encrypted volume and boot a condensed operating system used for installation. At step 308, the boot image may pass the password to the condensed operating system via a kernel command line argument.

At step 310, following boot of the kernel of the condensed operating system, a specialized module of the condensed operating system stored within the initial ramdisk may execute on CPU 102. In some embodiments, such specialized module may begin execution as a udev module completes execution. At step 312, the specialized module may detect the encrypted volume on the computer-readable media and decrypt the encrypted volume using the password passed to it via the kernel command line. After decryption, at step 314 the condensed operating system may detect the installation image stored within the encrypted volume.

At step 316, after the condensed operating system has completed boot, the installation image may execute on CPU 102 and install operating system 116 on information handling system 100 in accordance with the contents of the installation image. At step 318, after completion of installation in accordance with the contents of the installation image, the installation image may cause information handling system 102 to reboot and boot to the newly-installed operating system 116. Such reboot may also render the encrypted volume on the computer-readable media inaccessible unless the correct password is again entered. After completion of step 318, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using CPU 102 and/or any other system operable to implement method 300. In some embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding this disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A computer-implementable method comprising:
booting an information handling system from a boot image stored on a non-transitory computer-readable storage medium;
prompting, by the boot image, for a password for an encrypted volume of the non-transitory computer-readable storage medium;
loading, by the boot image, a kernel stored within the encrypted volume;
passing, by the boot image, the password to a specialized module stored within the encrypted volume;
decrypting, by the specialized module, the encrypted volume using the password; and
causing, by the specialized module, execution of an operating system installation image stored within the encrypted volume to install the operating system on the information handling system.

2. The method of claim 1, wherein the boot image passes the password to the specialized module via a command line argument of the kernel.

3. The method of claim 1, wherein the specialized module is stored in an initial ramdisk of the encrypted volume.

4. The method of claim 1, wherein the boot image is a Grand Unified Boot Loader image.

5. The method of claim 1, wherein the encrypted volume is a Linux Unified Key Setup volume.

6. The method of claim 1, further comprising causing, by the installation image, the information handling system to reboot after completion of installation of the operating system.

7. A system comprising:
a processor; and
a non-transitory, computer-readable storage medium embodying computer program code, the non-transitory, computer-readable storage medium being coupled to a data bus, the computer program code interacting with a plurality of computer operations and comprising instructions executable by the processor and configured for generating a second non-transitory computer-readable storage medium comprising a program of instructions configured for, when read and executed by a processing device:
booting an information handling system from a boot image stored on the non-transitory computer-readable storage medium;
prompting, by the boot image, for a password for an encrypted volume of the non-transitory computer-readable storage medium;
loading, by the boot image, a kernel stored within the encrypted volume;
passing, by the boot image, the password to a specialized module stored within the encrypted volume;
decrypting, by the specialized module, the encrypted volume using the password; and
causing, by the specialized module, execution of an operating system installation image stored within the encrypted volume to install the operating system on the information handling system.

8. The system of claim 7, wherein the boot image passes the password to the specialized module via a command line argument of the kernel.

9. The system of claim 7, wherein the specialized module is stored in an initial ramdisk of the encrypted volume.

10. The system of claim 7, wherein the boot image is a Grand Unified Boot Loader image.

11. The system of claim 7, wherein the encrypted volume is a Linux Unified Key Setup volume.

12. The system of claim 7, the instructions further configured for causing, by the installation image, the information handling system to reboot after completion of installation of the operating system.

13. A non-transitory, computer-readable storage medium embodying computer program code, the computer program code comprising computer executable instructions configured for:
booting an information handling system from a boot image stored on a non-transitory computer-readable storage medium;
prompting, by the boot image, for a password for an encrypted volume of the non-transitory computer-readable storage medium;
loading, by the boot image, a kernel stored within the encrypted volume;
passing, by the boot image, the password to a specialized module stored within the encrypted volume;
decrypting, by the specialized module, the encrypted volume using the password; and
causing, by the specialized module, execution of an operating system installation image stored within the encrypted volume to install the operating system on the information handling system.

14. The storage medium of claim 13, wherein the boot image passes the password to the specialized module via a command line argument of the kernel.

15. The storage medium of claim 13, wherein the specialized module is stored in an initial ramdisk of the encrypted volume.

16. The storage medium of claim 13, wherein the boot image is a Grand Unified Boot Loader image.

17. The storage medium of claim 13, wherein the encrypted volume is a Linux Unified Key Setup volume.

18. The storage medium of claim 13, the instructions further configured for causing, by the installation image, the information handling system to reboot after completion of installation of the operating system.
